(19) United States
(12) Patent Application Publication
(10) Pub. No.: US 2013/0304329 A1
(43) Pub. Date: Nov. 14, 2013

(54) Method for Operating a Compressed Air Brake System

(71) Applicant: WABCO GMBH, Hannover (DE)

(72) Inventors: Konrad Feyerabend, Hannover (DE); Otmar Struwe, Hannover (DE)

(73) Assignee: WABCO GmbH, Hannover (DE)

(21) Appl. No.: 13/717,176

(22) Filed: Dec. 17, 2012

(30) Foreign Application Priority Data
May 10, 2012 (DE) DE102012009186.9

(51) Int. Cl. B60T 13/26; B60W 10/30; B60W 30/18; B60W 10/184

(52) U.S. Cl. CPC B60T 13/268; B60W 10/184; B60W 10/30; B60W 30/18172; B60W 2600/00
USPC 701/48; 701/70

(57) ABSTRACT

A method for operating a compressed air brake system in a motor vehicle equipped with a brake control device includes regulating the generation of compressed air and/or the supply of compressed air into a storage container and, in particular, the regeneration of an air conditioning system, using a compressor controller, and carrying out calculations for the compressor control in the brake control device.

### CROSS-REFERENCE TO RELATED APPLICATION

This application claims the benefit of DE 10 2012 009 186.9 filed on May 10, 2012, the disclosure of which is hereby incorporated herein by reference in its entirety.

### FIELD OF THE INVENTION

The present invention generally relates to methods for operating a compressed air brake system in a motor vehicle.

### BACKGROUND OF THE INVENTION

Components of a motor vehicle compressed air brake system include, inter alia, a compressed air storage container, a compressor and a compressor controller. In addition, an air conditioning system may be present, in particular with an air dryer. The compressor controller is typically integrated into an electronic control unit (ECU), which is provided for it. In addition to the ECU for the compressor controller, further ECUs for other functions are present in the vehicle, in particular a brake control device, preferably with a closed-loop braking intervention controller and an engine control device. The various ECUs exchange data with one another via a data bus. A CAN bus is generally used as a data bus in vehicles.

The brake control device having the functions for a service brake of the vehicle is a component that is highly relevant to road safety and is correspondingly configured, in particular in terms of computational capacity, speed and fail safety. The brake control device makes available anti-lock braking system (ABS) functionality, electronic braking system (EBS) functionality or other similar functionalities. System components may include a traction control system (TCS), an electronic stability program (ESP) with rollover prevention (ROP) or yaw protection (YP) or further functions.

The compressor controller as a function of one of the ECUs in the vehicle carries out relatively simple operations. For example, the actual pressure in a compressed air storage container is interrogated, compared with a lower limiting value, and when the limiting value is undershot compressed air generated by a compressor is stored in the storage container. There has hitherto been a fixed minimum switch-on pressure, the compressor always having to be switched on when the switch-on pressure is undershot - irrespective of the state of the vehicle. This minimum switch-on pressure arises from legal requirements, for example that eight braking operations must still be possible with the stored compressed air energy in the event of the compressor failing. In known systems, the minimum switch-on pressure is permanently configured for the most unfavorable case that can be assumed, that is, a fully laden vehicle and further parameters.

In addition, the compressor controller may be part of an electronically controlled air conditioning function that also regulates the regeneration of the air dryer. The air dryer absorbs moisture from the compressed air generated by the compressor. The moisture from the air dryer is removed again cyclically. For this purpose, largely expanded, dry air flows out of the compressed air system through the air dryer in the opposite direction and carries the moisture away.

In order to optimize the compressor controller, it may be appropriate to include further parameters and/or carry out more complex calculations. This requires more computational power and a consequently more costly ECU for the compressor controller.

### SUMMARY OF THE INVENTION

Generally speaking, it is an object of the present invention to maximize optimization of the compressor controller without expanding the separate ECU, which is typically provided for the compressor controller.

According to an embodiment of the present invention, calculations for the compressor controller are also carried out in the brake control device. In this context, the calculations do not have to be carried out completely in the brake control device. Even partial transfer of the calculations permits the particular advantages of the brake control device to be utilized.

According to a further embodiment of the invention, data from sensors that are connected to the brake control device and that can be read out by the brake control device are used for the calculations. The reading out of these sensors is considerably more precise and quicker than the transfer of data via the CAN bus. Correspondingly, data can be used in real time for calculations for the compressor controller. Furthermore, the indirectly connected sensors supply data with a high resolution that is significantly higher than that of the data transmitted via the CAN bus. Therefore, more precise and differentiated calculations are possible. The sensors that are read out by the brake control device include, in particular, wheel speed sensors.

Air pressure in the compressed air brake system can be measured and can be compared with a lower limiting value calculated in the brake control device. When the limiting value is undershot, compressed air is fed into the storage container. The calculated lower limiting value can be made available to other ECUs, in particular to the ECU performing the compressor control.

The lower limiting value is preferably a minimum threshold value or the minimum switch-on pressure, that, when undershot, always switches on the compressor, irrespective of the energy efficiency of the compressed air generation or of the state of the vehicle, in order to generate compressed air and also feed it into the storage container or into the compressed air brake system. Preferably, the minimum switch-on pressure can be configured in a variable fashion, and can be lowered further than conventional systems under optimum driving conditions in order to achieve a greater savings potential.

According to an embodiment of the present invention, the lower limiting value can be adapted dynamically, in particular on the basis of one or more data items from the following:

a) rotational wheel speeds,

b) changes in rotational wheel speed,

c) differences in rotational speed between/among the vehicle wheels,

d) current inclination of the road and bends, in particular using position sensors and acceleration sensors or a navigation device,

e) historical inclination of the road and bends, in particular using the navigation device,

f) current velocity,

g) state of the road and/or friction, in particular using wheel speed differences and/or slippage,

h) lateral acceleration, preferably according to frequency and magnitude, in particular by way of data from a sensor found in the brake control device, for determining the stability of the vehicle,

i) evaluation of route data, navigation device data, GPS, in particular the prevailing inclination of the road and bends,

j) external temperature,

k) engine data and transmission data, in particular load, rotational speed, gear speed, and

l) braking requests of external control devices via the data bus, for example via an External Brake Request (XBR).

The dynamic, permanent or cyclical adaptation of the lower limiting value while the motor vehicle is travelling or at least during operation thereof allows the energy consumption for the cyclical filling of the storage container to be optimized. At the same time, load peaks in the drive can be avoided.

The lower limiting value, which is calculated in the brake control device, can be transmitted to the compressor controller via a data bus. The compressor controller can be integrated into an electronic control device for the compressed air conditioner. The lower limiting value is transferred thereto via the CAN bus.

In an embodiment of the invention, all the calculations for a compressor control process and/or a process of controlling the air conditioning system are carried out in the brake control device. This permits one or two control devices (ECUs) to be eliminated.

A solenoid valve for controlling the compressor is advantageously actuated by the brake control device. The solenoid valve is, in particular, a solenoid valve that can be used to control pressure relief at the compressor or activation of a clutch between the compressor and a drive engine. The specified pressure relief can comprise, for example, access to a non-pressurized volume or to an open volume that is only under a small pressure—the compressor therefore operating largely without a counterpressure.

In an embodiment of a method according to the present invention, the compressor controller also reads out data from wheel speed sensors and at least evaluates the data. As a result of the evaluation, additional data can flow into the compressor controller, for example the current speed, acceleration and braking processes on the basis of changes in rotational speed. If the wheel speed sensors are directly connected to the control device for the compressor controller, additional data can be acquired with high resolution and used for calculations, as noted above. The energy-efficient control of the compressor can therefore take place independently of data of other control devices, that is, even in the case of failure of the data bus. Even energy-efficient control is possible without the control device being connected to a data bus.

The compressor controller can evaluate wheel speed sensors of driven and non-driven wheels of the motor vehicle and can calculate differences in rotational speed. The microslip that occurs both in load phases and in overrun phases of the vehicle leads to differences in rotational speed between the wheel speed sensors. Accordingly, the load phases and overrun phases can be used as criteria for the compressor controller. The feeding in of compressed air during the load phases can therefore be avoided and preferably instigated in overrun phases.

Furthermore, according to an embodiment of the present invention, the compressor controller can correlate values of the wheel speed sensors with values of an engine controller of the vehicle. This may be used, for example, for checking the plausibility of the values of the wheel speed sensors or for bringing about an overall further improvement in the compressor controller. A load can also be determined on the basis of the engine load, change in rotational speed and gradient and/or horizontal attitude.

According to an embodiment of the invention, the compressor controller can be part of an electronic air conditioning function that also regulates the regeneration of the air conditioning system, in particular of an air dryer, and the regeneration of the air conditioning system can be coordinated with the generation of the compressed air. This avoids the need for an additional electronic control device, as does the overlapping of the generation of the compressed air with the regeneration of the air conditioning system.

The compressor controller and/or the electronic air conditioning function can advantageously also receive information from braking processes, in particular brake pedal information. The latter can be determined from states and values of switches, travel sensors and pressure sensors, in each case with respect to the brake pedal.

The compressor controller and/or the electronic air conditioning function can advantageously also receive braking requests from external control devices via the data bus, for example in the form of an XBR.

The integration of further functions into the compressor controller is also advantageous, wherein the further functions evaluate wheel speed information, in particular pertaining to a closed-loop braking intervention control system. In this way, the compressor controller can be combined with an ABS, an EBS, another closed-loop braking intervention control system, a TCS, an ESP or further functions.

According to an embodiment of the invention, algorithms for a compressor controller and/or a controller for an air conditioning system are implemented in the brake control device. In this context, the compressor controller can be completely implemented in the brake control device or else only individual calculations of the compressor controller can be implemented therein.

Algorithms for calculating a lower limiting value for a pressure in the compressed air brake system can also advantageously be implemented in the brake control device. When this limiting value is undershot, a compressor typically supplies compressed air into the storage container of the compressed air brake system.

Furthermore, algorithms for switching one or more solenoid valves for the compressor controller can be implemented in the brake control device. These are preferably solenoid valves with which the compressor or the generated compressed air is connected or by which pressure relief can be brought about at the compressor.

According to another embodiment of the invention, wheel speed sensors are connected to a control device for a compressor controller of the vehicle compressed air brake system and can be read out by the control device.

Still other objects and advantages of the present invention will in part be obvious and will in part be apparent from the specification.

The present invention accordingly comprises the various steps and the relation of one or more of such steps with respect to each of the others, and embodies features of construction, combinations of elements, and arrangement of parts, which are adapted to effect such steps, all as exemplified in the following detailed disclosure, and the scope of the invention will be indicated in the claims.

### BRIEF DESCRIPTION OF THE DRAWINGS

For a fuller understanding of the inventive embodiments, reference is had to the following description taken in connection with the accompanying drawings in which:

FIGS. 1 and 2 are schematic diagrams of parts of a vehicle compressed air brake system in accordance with exemplary embodiments of the present invention.

### LIST OF REFERENCE NUMBERS

10 brake control device
11 wheel speed sensor
12 wheel speed sensor
13 driven wheel
14 driven wheel
15 wheel speed sensor
16 wheel speed sensor
17 following wheel
18 following wheel
19 modulator
20 modulator
21 CAN bus
22 control device
23 compressor
24 solenoid valve
25 solenoid valve
26 line
27 sound damper
28 air dryer
29 line
30 non-return valve
31 arrow
32 line
33 line
34 throttle
35 non-return valve
36 line
37 line
38 line
39 purge valve
40 line
41 control line

### DETAILED DESCRIPTION OF THE PREFERRED EMBODIMENTS

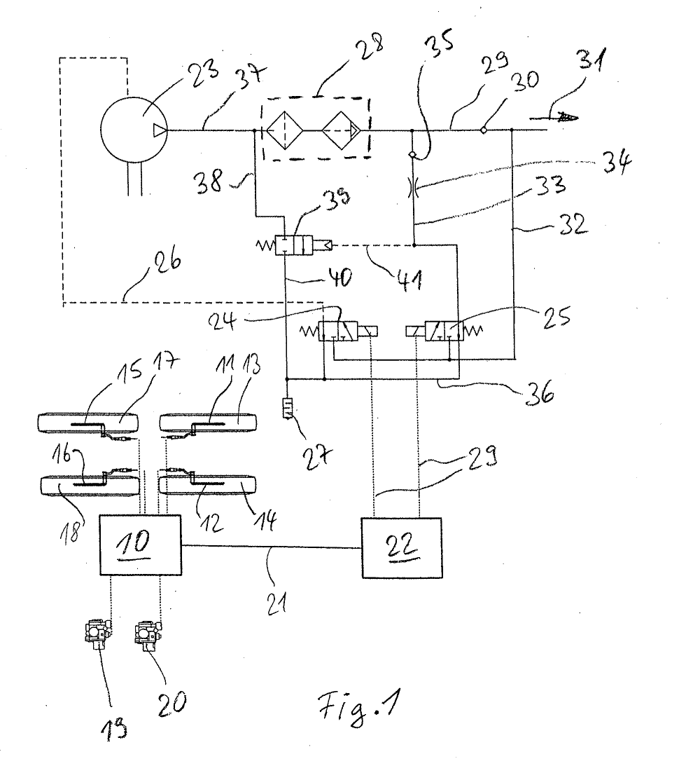

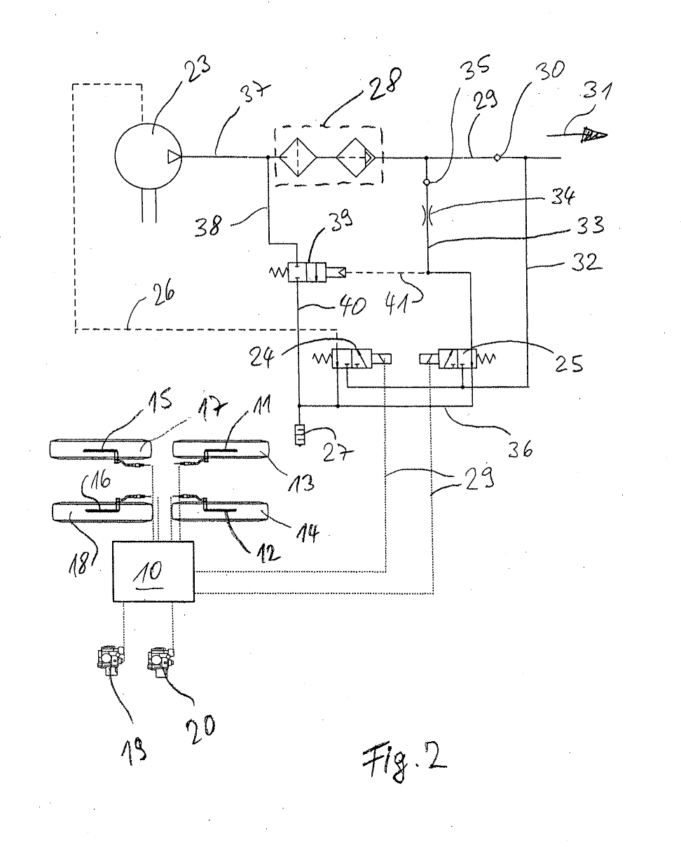

Referring now to the drawing figures, FIGS. 1 and 2 show exemplary embodiments of compressed air brake systems for a service brake in a motor vehicle. A brake control device 10 with closed-loop braking intervention control system, analogous to an ABS or EBS, directly reads out data from wheel speed sensors 11, 12 at driven wheels 13, 14 and from wheel speed sensors 15, 16 at following wheels 17, 18. The brake control device actuates in a known fashion pneumatic valves for regulating the function of compressed air brakes (not shown). These pneumatic valves are referred to here as modulators 19, 20.

In the embodiment depicted in FIG. 1, the brake control device 10 is connected via a CAN bus 21 to a control device 22 for an air conditioning system. Alternatively or additionally, the control device 22 can be provided for a compressor controller.

The switching over of a compressor 23 between feeding mode and idling mode is controlled by a solenoid valve 24, which, for reasons of better clarity, is shown adjacent to a solenoid valve 25 and near to the control device 22, but can also be integrated in the compressor. The solenoid valves 24, 25 are actuated by the control device 22. The solenoid valve 24 serves to control the compressor via a pneumatic control line 26. At the same time, the solenoid valve 24 is connected to a sound damper 27. Electrical control lines for the solenoid valves 24, 25 are denoted here by the reference numbers 28, 29.

The component of the compressed air brake system is also an air dryer 28, which typically contains a desiccant in the form of a dryer cartridge. A line 29 leads from the air dryer 28 via a non-return valve 30 to a multi-circuit protection valve (not shown) with storage containers for the compressed air (see arrow 31). A line 32 also branches off to the solenoid valves 24, 25 downstream of the non-return valve 30. The solenoid valve 25 is connected via a line 33, with throttle 34 and non-return valve 35, to the line 29 upstream of the non-return valve 30. The solenoid valve 25 is also connected to the solenoid valve 24 and to the sound damper 27 via a line 36.

Between the compressor 23 and the air dryer 28, a line 38 branches off from a line 37 to a purge valve 39, which is connected to the sound damper 27 via a line 40. The purge valve 39 is controlled by the pressure present in the line 33 (see pneumatic control line 41 shown in dashed lines).

In order to regenerate the air dryer 28, the solenoid valve 25 is activated and assumes the position shown in FIG. 1. As a result, the pressure from the storage container or from the line 32 is present on the line 33. The purge valve 39 is correspondingly moved into the position whereby the lines 38 and 40 are connected. Furthermore, compressed air expands at the throttle 34 and flows through the air dryer 28, picks up the moisture there and passes into the open air via the lines 38, 40 and the sound damper 27.

The control device 22 controls the function of the solenoid valves 24, 25, as stated above. The information, which is made available via the CAN bus 21 and is available in the brake control device 10 and/or information originating from other control devices can be taken into account in this context. An important function of the control device 22 is switching the solenoid valve 24 as a function of a minimum lower limiting value of the compressed air in the storage container (not shown) or in the lines connected thereto. The minimum lower limiting value is not predefined statically here but rather calculated dynamically, in particular in the brake control device 10, and on the basis of the determined values of the wheel speed sensors 11, 12 and 15, 16.

The values supplied by the wheel speed sensors 11, 12 and 15, 16 can also be included in the control of the air conditioning system, that is, in the switching of the valve 25 and the regeneration of the air dryer 28.

The difference between the embodiments depicted in FIG. 1 and FIG. 2 is the arrangement of the control device 22. The latter is not shown in FIG. 2. All the functions of the compressor controller, including the air conditioning, are triggered by the brake control device 10 in FIG. 2. The lines 29 are correspondingly connected directly to the brake control device 10.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A method for operating a vehicle compressed air brake system equipped with a brake control device, the method comprising regulating at least one of the generation of compressed air by a compressor and the supply of compressed air into a storage container using a compressor controller; and effecting calculations for the compressor controller at least in part in the brake control device.

2. The method as claimed in claim 1, further comprising obtaining data from sensors connected to the brake control device; and basing the calculations on the data.

3. The method as claimed in claim 1, further comprising measuring air pressure in the compressed air brake system; comparing the measured air pressure with a lower limit value calculated in the brake control device; and when the limit value is undershot, automatically switching on the compressor independently of the energy efficiency of the generation of compressed air or of the state of the vehicle to feed compressed air into one of the storage container and the compressed air brake system.

4. The method as claimed in claim 3, wherein the lower limit value is dynamically adaptable based on at least one of: (i) rotational speeds of wheels of the vehicle, (ii) changes in rotational speed of the wheels, (iii) differences in rotational speed between the wheels, (iv) current data for roadway inclination and bends, (v) historical data for roadway inclination and bends, (vi) current velocity of the vehicle, (vii) frictional state of the roadway, (viii) lateral acceleration of the vehicle, (ix) evaluation of at least one of route data and navigation device data, (x) external temperature, (xi) vehicle engine data, (xii) vehicle transmission data, and (xiii) braking requests of external control devices via a data bus.

5. The method as claimed in claim 3, further comprising transmitting the lower limit value to the compressor controller via a data bus.

6. The method as claimed in claim 1, wherein all calculations for at least one of controlling the compressor and controlling an air conditioning system of the vehicle are effected in the brake control device.

7. The method as claimed in claim 1, further comprising using the brake control device to actuate a solenoid valve for controlling the compressor.

8. A method for operating a compressed air brake system in a motor vehicle equipped with a brake control device, the method comprising using a compressor controller to regulate (i) at least one of the generation of compressed air by a compressor and the supply of compressed air into a storage container, and (ii) the regeneration of an air conditioning system of the vehicle; and obtaining and evaluating data from wheel speed sensors using the compressor controller.

9. The method as claimed in claim 8, wherein evaluating data from wheel speed sensors using the compressor controller includes evaluating wheel speed

[symbol]

15. The brake control device as claimed in claim 14, the brake control device being configured to implement algorithms for calculating a lower limit value for a pressure in the compressed air brake system.

16. The brake control device as claimed in claim 14, the brake control device being configured to implement algorithms for switching at least one solenoid valve for the compressor controller.

17. A control device for a compressor controller for an air conditioning system of a motor vehicle equipped with a compressed air brake system, the control device being connected to wheel speed sensors of the vehicle.

18. A vehicle comprising a brake control device as claimed in claim 14.

19. A vehicle comprising a compressor controller as claimed in claim 17.

20. The method as claimed in claim 1, wherein the compressor controller regulates the regeneration of an air conditioning system of the vehicle.
